(19) United States
(12) Patent Application Publication
(10) Pub. No.: US 2010/0167645 A1
(43) Pub. Date: Jul. 1, 2010

(54) INFORMATION PROCESSING APPARATUS

(75) Inventor: Satoshi KAWASHIMO, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/608,770

(22) Filed: Oct. 29, 2009

(30) Foreign Application Priority Data
Dec. 25, 2008 (JP) 2008-330846

(51) Int. Cl. H04B 5/00

(52) U.S. Cl. 455/41.1

(57) ABSTRACT

According to one embodiment, an information processing apparatus includes a housing, a display attached to the housing to open and close, a display signal generator in the housing and configured to generate a display signal to the display, a first communication module in the housing and configured to perform close-proximity wireless transfer, a second communication module in the display configured to be in contact with the first communication module when the display is open with respect to the housing, and a controller configured to control the information processing device to transmit the display signal to the second communication module via the first communication module when the first and second communication modules are in contact with each other.

### CROSS-REFERENCE TO RELATED APPLICATIONS

This application is based upon and claims the benefit of priority from Japanese Patent Application No. 2008-330846, filed Dec. 25, 2008, the entire contents of which are incorporated herein by reference.

### BACKGROUND

1. Field

One embodiment of the present invention relates to a technique for executing close-proximity wireless transfer and, more particularly, to an information processing apparatus which can change the directivity of communication by pivoting a communication module.

2. Description of the Related Art

In recent years, for an information apparatus with a display, there has been proposed a technique for wirelessly transmitting a display signal produced by the information apparatus to the display.

For example, Jpn. Pat. Appin. KOKAI Publication No. 2008-83679 discloses the following technique. That is, a display unit receives, in a non-contact manner as an electromagnetic wave signal such as a UWB signal, a signal sent from a display control module (controller), and displays it.

In Jpn. Pat. Appln. KOKAI Publication No. 2008-83679, however, a signal sent from the display control module is transmitted to the display unit in a non-contact manner. That is, it is necessary to raise the output level of a radio wave for outputting the signal in a non-contact manner, thereby increasing power consumption. Furthermore, the radio wave may interfere with that of another wireless apparatus.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing the outer appearance of an information processing apparatus according to an embodiment of the present invention;

FIG. 2 is an exemplary block diagram showing the system configuration of the information processing apparatus according to the embodiment;

FIG. 3 is an exemplary block diagram for explaining a configuration for executing close-proximity wireless transfer between a computer main body and display unit of the information processing apparatus according to the embodiment;

FIG. 4 is an exemplary view for explaining the concept of an arrangement in which the display unit is closed with respect to the computer main body of the information processing apparatus according to the embodiment;

FIG. 5 is an exemplary view for explaining the concept of an arrangement in which the display unit is open with respect to the computer main body of the information processing apparatus according to the embodiment;

FIG. 6 is an exemplary perspective view for explaining the arrangement of the information processing apparatus according to a modification example of the embodiment;

FIG. 7 is an exemplary sectional view for explaining the concept of an arrangement in which the display unit is open with respect to the computer main body of the information processing apparatus according to the modification example; and

FIG. 8 is an exemplary sectional view for explaining the concept of an arrangement in which the display unit is closed with respect to the computer main body of the information processing apparatus according to the modification example.

### DETAILED DESCRIPTION

Various embodiments according to the invention will be described hereinafter with reference to the accompanying drawings. In general, according to one embodiment of the invention, an information processing apparatus comprises: a housing; a display unit attached to the housing to open and close; a display signal generator in the housing and configured to generate a display signal to the display; a first communication module in the housing and configured to execute close-proximity wireless transfer; a second communication module in the display configured to be in contact with the first communication module when the display is open with respect to the housing; and a controller configured to control to transmit the display signal to the second communication module via the first communication module when the first and second communication modules are in contact with each other.

An embodiment of the present invention will be described below with reference to the accompanying drawings.

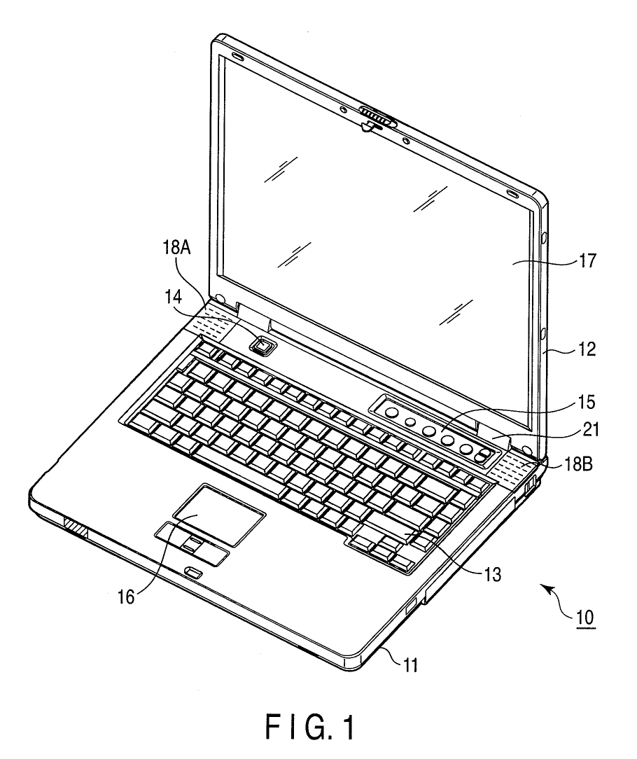

First, the arrangement of an information processing apparatus according to the embodiment of the present invention will be explained with reference to FIG. 1. The information processing apparatus of this embodiment is implemented as, e.g., a portable notebook personal computer 10.

The personal computer 10 has a function of executing communication between a main body 11 and a display unit 12 using close-proximity wireless transfer. When the display unit 12 is closed, the communication units of the main body 11 and display unit 12 are spaced apart from each other so as not to be able to execute close-proximity wireless transfer. Furthermore, when the display unit 12 is open, the communication units of the main body 11 and display unit 12 are in contact with each other so as to be able to perform close-proximity wireless transfer. By bringing the communication units of the main body 11 and display unit 12 into contact with each other to execute close-proximity wireless transfer, it is possible to suppress the power consumption even in wireless communication, and reduce interference with other wireless apparatuses.

FIG. 1 is a perspective view showing a state in which the display unit of the computer 10 is open. In the computer 10, it is possible to execute close-proximity wireless transfer with the main body 11 by opening the display unit 12.

The computer 10 includes the computer main body (housing) 11 and display unit 12. The display unit 12 has a built-in display device formed from a thin-film transistor liquid crystal display (TFT-LCD) 17.

The display unit 12 is attached to the computer main body 11 to freely pivot (open/close) via hinge modules 21 between the open position where the upper surface of the computer main body 11 is exposed and the closed position where that upper surface is covered. The computer main body 11 has a thin box-shaped housing and includes, on its upper surface, a keyboard 13, a power button 14 to power the computer 10 on and off, an input operation panel 15, a touchpad 16, and loudspeakers 18A and 18B.

Each of the hinge modules 21 and main body 11 incorporates a communication module for executing close-proximity wireless transfer between the display unit 12 and the main body 11. Close-proximity wireless transfer uses, e.g., a wireless communication technology such as TransferJet which uses an induced electric field and has directivity. Note that it is possible to apply various kinds of wireless communication as far as close-proximity wireless transfer which uses an induced electric field and has directivity is utilized.

The input operation panel 15 is an input device for inputting an event corresponding to a pressed button, and has a plurality of buttons to activate a plurality of functions.

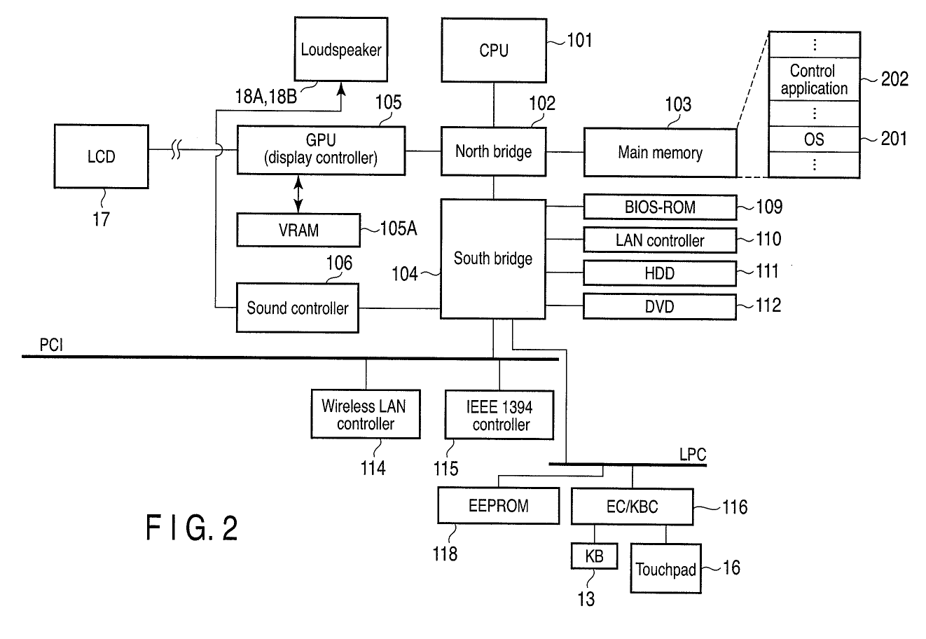

The system configuration of the computer 10 will be described next with reference to FIG. 2.

As shown in FIG. 2, the computer 10 includes a CPU 101, a north bridge 102, a main memory 103, a south bridge 104, a graphics processing unit (GPU: circuit module) 105, a video memory (VRAM) 105A, a sound controller 106, a BIOS-ROM 109, a LAN controller 110, a hard disk drive (HDD) 111, a DVD drive 112, a wireless LAN controller 114, an IEEE 1394 controller 115, an embedded controller/keyboard controller IC (EC/KBC) 116, the LCD 17, and an EEPROM 118.

The CPU 101 is a processor which controls the operation of the computer 10. The CPU 101 executes an operating system (OS) 201 and various application programs such as a control application program 202, which are loaded from the hard disk drive (HDD) 111 into the main memory 103. The control application program 202 is software for controlling a close-proximity wireless transfer function.

The north bridge 102 is a bridge device which interconnects the local bus of the CPU 101 and the south bridge 104. The north bridge 102 incorporates a memory controller to effect access control of the main memory 103. The north bridge 102 also has a function of communicating with the GPU 105 via, e.g., a serial bus complying with the Peripheral Component Interconnect (PCI) Express standard.

The GPU 105 is a display controller which controls the LCD 17 used as the display monitor of the computer 10. A display signal produced by the GPU 105 is sent to the LCD 17 of the display unit 12 using close-proximity wireless transfer.

The south bridge 104 controls devices on a Low Pin Count (LPC) bus and those on a PCI bus. The south bridge 104 incorporates an Integrated Drive Electronics (IDE) controller for controlling the hard disk drive (HDD) 111 and the DVD drive 112. The south bridge 104 also has a function of communicating with the sound controller 106.

The sound controller 106 is a sound generator, and outputs audio data to be played back to the loudspeakers 18A and 18B.

The wireless LAN controller 114 is a wireless communication device which performs wireless communication complying with, e.g., the IEEE 802.11 standard. The IEEE 1394 controller 115 communicates with an external apparatus via a serial bus complying with the IEEE 1394 standard.

The embedded controller/keyboard controller IC (EC/KBC) 116 is a single-chip microcomputer in which an embedded controller for power management and a keyboard controller for controlling the keyboard (KB) 13 and touchpad 16 are integrated. The embedded controller/keyboard controller IC (EC/KBC) 116 has a function of powering the computer 10 on/off in response to a user operation of the power button 14.

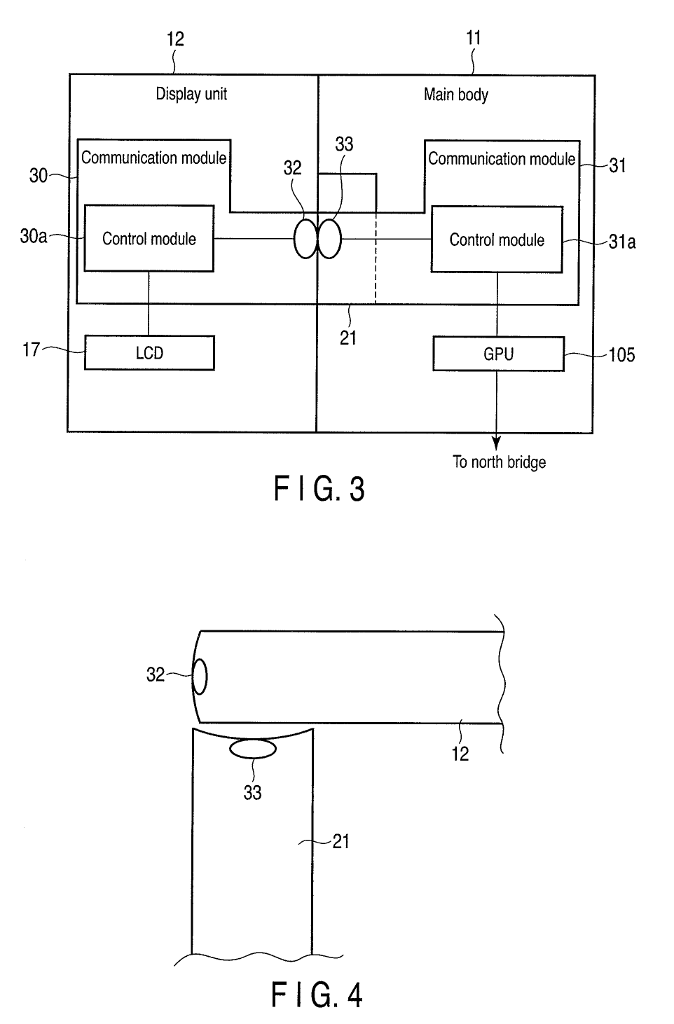

A configuration using the close-proximity wireless transfer between the main body 11 and display unit 12 of the computer 10 will be explained next with reference to the block diagram of FIG. 3.

The main body 11 of the computer 10 includes a communication module 31 having a control module (controller) 31a for controlling close-proximity wireless transfer and a coupler module 33. The hinge module 21 also incorporates the coupler module 33 serving as an antenna for executing close-proximity wireless transfer. The control module 31a outputs to the coupler module 33 a display signal sent from the GPU 105. The coupler module 33 transmits the display signal to a coupler module 32 (to be described later) using close-proximity wireless transfer.

The display unit 12 includes the LCD 17 and a communication module 30 having a control module 30a for controlling close-proximity wireless transfer and the coupler module 32. The coupler module 32 sends to the control module 30a the display signal transmitted from the coupler module 33 using close-proximity wireless transfer. The control module 30a outputs to the LCD 17 the display signal sent from the coupler module 32. Assume that the coupler modules 32 and 33 are brought into contact with each other to perform communication using close-proximity wireless transfer. It is possible to execute communication at a low output level by communicating in a contact manner. The coupler modules 32 and 33 serve as antennas for performing close-proximity wireless transfer such as TransferJet, and have directivities in opposite directions. For this reason, the coupler modules 32 and 33 need to oppose each other at all the time during communication. When the coupler modules 32 and 33 are a predetermined distance or more away from each other, they cannot communicate with each other due to the characteristics of close-proximity wireless transfer. Even when the coupler modules 32 and 33 no longer oppose each other, i.e., the modules are perpendicular to each other, they cannot execute communication.

As shown in FIG. 4, for example, when the coupler module 33 incorporated in the hinge module 21 is perpendicular to the coupler module 32 incorporated in the display unit 12, they cannot execute close-proximity wireless transfer with each other. Furthermore, as shown in FIG. 4, when the coupler modules 32 and 33 are not in contact with each other, and are the predetermined distance or more away from each other, they cannot perform close-proximity wireless transfer. In the above-mentioned state, i.e., in the state in which the coupler modules 32 and 33 cannot execute close-proximity wireless transfer, the display unit 12 is closed with respect to the main body 11 of the computer 10.

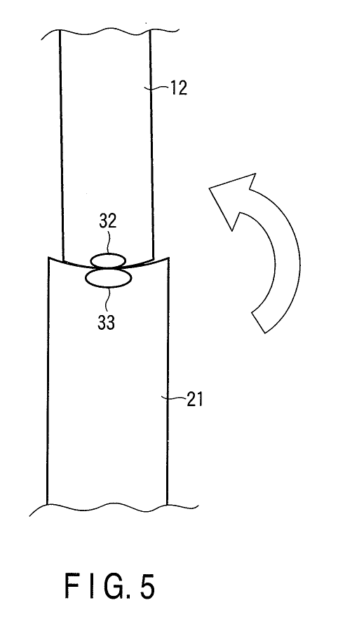

On the other hand, as shown in FIG. 5, when the coupler module 33 incorporated in the hinge module 21 opposes the coupler module 32 incorporated in the display unit 12, the modules can execute close-proximity wireless transfer with each other. Furthermore, as shown in FIG. 5, when the coupler modules 32 and 33 are in contact with each other (in FIG. 5, although the modules mechanically have a slight gap, they may be considered to be virtually in contact with each other), they can execute the close-proximity wireless transfer. In the above-described state, i.e., in the state in which the coupler modules 32 and 33 can perform close-proximity wireless transfer, the display unit 12 is open with respect to the main body 11 of the computer 10.

With such a mechanism, the coupler modules 32 and 33 are in contact with each other so as to be able to execute close-proximity wireless transfer when the display unit 12 is open with respect to the main body 11 of the computer 10. Furthermore, the coupler modules 32 and 33 are spaced apart from each other so as not to be able to execute close-proximity wireless transfer when the display unit 12 is closed with respect to the main body 11 of the computer 10.

According to the above-described embodiment, it is possible to transmit a display signal to a display unit at a low output level using close-proximity wireless transfer by bringing a transmission module and reception module into contact with each other. For this reason, it is possible to wirelessly transmit the display signal to the display unit and to suppress interference with surrounding wireless apparatuses while saving power, without arranging wiring lines for a display signal in the hinge module of the computer main body. Furthermore, the user can readily turn wireless communication on/off merely by opening/closing the display unit. By utilizing the characteristics of close-proximity wireless transfer, i.e., the directivity and communication distance, the wireless communication can be turned on/off without considering switch degradation. A module can be accomplished in software and hardware.

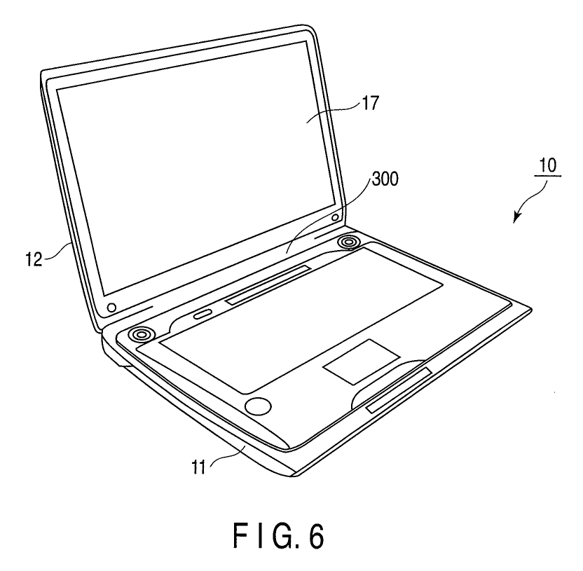

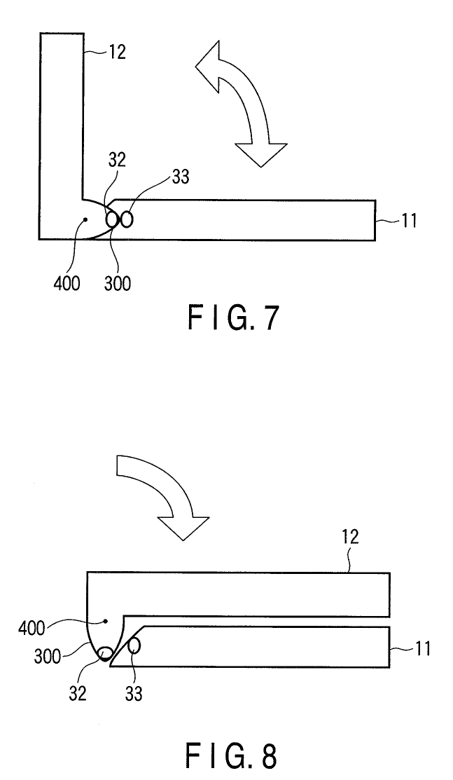

In addition to the above-described embodiment, a mode such as a modification example to be described below may be used. Any mode is available as far as wireless communication is turned on/off by opening/closing a display unit. As shown in FIG. 6, for example, the present invention is applicable to a case in which the display unit 12 and a hinge module 300 of the notebook computer 10 are integrated. In the case of the computer 10 with such an arrangement, the hinge module 300 is located almost at the center of the main body 11 of the computer 10. The display unit 12 can move up to the same position as that of the main body 11 of the computer 10 by pivoting the hinge module 300. In this case, as shown in FIG. 7, the hinge module 300 pivots about a rotation axis 400 incorporated in itself.

FIG. 7 is a sectional view showing a case in which the main body 11 and display unit 12 of the computer 10 described above are connected. The hinge module 300 integrated with the display unit 12 incorporates the coupler module 32 for close-proximity wireless transfer. The main body 11 of the computer 10 incorporates the coupler module 33 for close-proximity wireless transfer with the coupler module 32.

In the computer 10 with such an arrangement, as shown in FIG. 7, since the coupler module 32 incorporated in the hinge module 300 opposes the coupler module 33 incorporated in the main body 11 of the computer 10, the modules can execute close-proximity wireless transfer with each other. Furthermore, since the coupler modules 32 and 33 are in contact with each other (in FIG. 7, although the modules mechanically have a slight gap, they may be considered to be virtually in contact with each other), they can perform close-proximity wireless transfer. In the above-mentioned state, i.e., in the state in which the coupler modules 32 and 33 can execute close-proximity wireless transfer, the display unit 12 is open with respect to the main body 11 of the computer 10.

On the other hand, as shown in FIG. 8, when the coupler module 32 incorporated in the hinge module 300 is perpendicular to the coupler module 33 incorporated in the main body 11 of the computer 10, the modules cannot execute close-proximity wireless transfer with each other. When the coupler modules 32 and 33 are not in contact with each other, and are a predetermined distance or more away from each other, they cannot perform close-proximity wireless transfer. In the above-described state, i.e., in the state in which the coupler modules 32 and 33 cannot execute close-proximity wireless transfer, the display unit 12 is closed with respect to the main body 11 of the computer 10.

The above-described modification example is also a mode in which wireless communication is turned on/off by opening/closing the display unit. It is, therefore, possible to obtain the same effects as in the above-described embodiment.

The present invention is not exactly limited to the above embodiments, and constituent elements can be modified upon practice without departing from the spirit and scope of the invention. Various inventions can be formed by properly combining a plurality of constituent elements disclosed in the above embodiments. For example, several constituent elements may be omitted from all the constituent elements described in the embodiments. A module can be accomplished in software and hardware. In addition, constituent elements throughout different embodiments may be properly combined.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a housing;
a display attached to the housing and configured to open and close;
a display signal generator in the housing and configured to generate a display signal to the display;
a first communication module in the housing and configured to execute close-proximity wireless transfer;
a second communication module in the display configured to be in contact with the first communication module when the display is open with respect to the housing; and
a controller configured to control the information processing device to transmit the display signal to the second communication module via the first communication module when the first and second communication modules are in contact with each other.

2. The apparatus of claim 1, wherein the second communication module is in the display at a position outside of a coverage area of close-proximity wireless transfer with the first communication module when the display is closed with respect to the housing.

3. The apparatus of claim 1, wherein the housing is configured to transmit a video signal to the display with close-proximity wireless transfer when the first and second communication modules are in contact with each other.

4. The apparatus of claim 1, wherein the first and second communication modules comprise directivities, and are configured such that the first and second directivities of the first and second communication modules are substantially opposite to each other when the display is open with respect to the housing, and the first and second directivities of the first and second communication modules are substantially perpendicular to each other when the display is closed with respect to the housing.

5. The apparatus of claim 1, wherein the first and second communication modules are configured to execute close-proximity wireless transfer using an induced electric field.

6. The apparatus of claim 1, wherein the housing further comprises a hinge as a pivot for opening and closing the display, and the first communication module is in the hinge.
